(19) United States
(12) Patent Application Publication
(10) Pub. No.: US 2013/0144994 A1
(43) Pub. Date: Jun. 6, 2013

(54) Content Delivery Network and Method for Content Delivery

(71) Applicants: Lichun Li, Shenzhen (CN); Jun Wang, Shenzhen (CN)

(72) Inventors: Lichun Li, Shenzhen (CN); Jun Wang, Shenzhen (CN)

(73) Assignee: ZTE CORPORATION, Shenzhen, GD (CN)

(21) Appl. No.: 13/817,200

(22) PCT Filed: Jul. 26, 2011
(86) PCT No.: PCT/CN11/77621

§ 371 Date: Feb. 15, 2013

(30) Foreign Application Priority Data
Aug. 16, 2010 (CN) 201010257565.X

(51) Int. Cl. G06F 15/177

(52) U.S. Cl. CPC G06F 15/177
USPC 709/220

(57) ABSTRACT

The disclosure provided a content delivery network, which comprises a content locating system, a delivery configuration managing system and at least one content providing node; wherein the content providing node is configured to acquire and provide a content; the content locating system is configured to determine a download location of a content requested to be downloaded and provide the determined download location information to a content download requester; and the delivery configuration managing system is configured to maintain and/or generate the delivery configuration information of the content, determining a delivery configuration of the content to be downloaded according to the received information of the content requested to be downloaded, and notify the same to the download requester. Further the disclosure provided a method for content delivery on the basis of the content delivery network described above. The technical solution of the disclosure supports various content delivery configurations with relatively low complexity and costs.

### FIELD OF THE INVENTION

The disclosure relates to content delivery technology, and in particular to a content delivery network and a method for content delivery.

### BACKGROUND OF THE INVENTION

FIG. 1 is a schematic diagram of composition structure of a content delivery network in the prior art. As shown in FIG. 1, the content delivery network (CDN) is an overlay network based on an IP layer network and is configured to deliver contents from content sources to users. The CDN includes content source nodes, a content locating system, content providing nodes and content download nodes (CDN clients). In the CDN, the content source nodes, the content locating system and the content providing nodes are at network. The content source nodes, as the content providing source, are stored with various contents provided to users. The content locating system is configured to determine location of content requested to be downloaded by a user, and a better content providing node providing contents to the user. The content providing node is configured to download the corresponding content from the content source node and provide it to the user requesting for the content. The provision of the CDN technology is mainly to relieve the pressure on the network and content sources brought by the increase of users and services so as to ensure the users in every corner can also enjoy good content providing service. By scheduling and transmitting contents from content sources to the CDN content providing node at the edge of the network, the CDN enables users to access contents from the nearest content providing node, thus reducing the traffic of the backbone network, saving capacity expansion for operators, increasing the speed for users to accessing contents and relieving the pressure on content sources. Generally speaking, a content providing node comprises a special server. Some CDNs adopt Peer to Peer (P2P) technology, thus user nodes can also help content sources deliver contents and can act as all or partial content providing nodes at the edge of the network, which ensures the convenience for users at the edge of the network to obtain contents and improves the fastness of content obtaining.

At present, to improve service quality of webpage browsing, Internet Protocol Television or Interactive Personal Television (IPTV), Video on Demand (VoD), online music, file downloading and other services, and to ensure traffic of these services, the CDN can support delivery of webpage, streaming media, files and other kinds of contents. There are different types of CDNs for different types of delivery contents, so content delivery can be realized with various different methods. FIG. 2A is a flow chart of the existing content delivery based on HTTP. As shown in FIG. 2A, for webpage contents, the CDN usually adopts Domain Name System (DNS) direction and Hyper Text Transfer Protocol (HTTP) redirection to direct users' HTTP requests to a cache server of the CDN (content source nodes or content providing nodes) and then users adopt HTTP protocol to single-channel download corresponding contents. For streaming media contents, the CDN usually adopts Real Time Streaming Protocol (RTSP) to redirect to a cache server of the CDN requested by users, and then users adopt Realtime Transport Protocol (RTP) single channel to download the content. FIG. 2B is a flow chart of the existing content delivery based on P2P. As shown in FIG. 2, in the CDN adopting P2P downloading, users inquire cache server and peer node list by using P2P protocol to multiple-download related contents.

At present, there exist various CDNs using different delivery methods. It is because that various content delivery methods adopt different content locating and downloading methods; in order to adapt to different delivery methods, operators have to establish multiple content delivery networks. The use of multiple different content delivery networks increases complexity and cost of the development, construction, operation and maintenance, etc. of the CDN. No effective solution is put forward to the problem in the traditional art that the complexity and cost increase of development and maintenance, etc. caused by multiple CDNs.

### SUMMARY OF THE INVENTION

In view of this, the disclosure provides a content delivery network and a method for content delivery to realize content delivery flexibly and conveniently, relieve load pressure on backbone network and optimize content delivery network.

To achieve the objective above, the disclosure adopts the following technical solution.

According to one accept of the disclosure, a content delivery network is provided, comprising: a content locating system, a delivery configuration managing system and at least one content providing node; wherein, the content providing node is configured to acquire and provide a content; the content locating system is configured to determine a download location of a content requested to be downloaded and provide the determined download location information to a content download requester; and the delivery configuration managing system is configured to maintain and/or generate delivery configuration information of the content; determine a delivery configuration of the content to be downloaded according to received information of the content requested to be downloaded, and notify the delivery configuration to the download requester.

Preferably, the content locating system is further configured to acquire current loading conditions, content availability and network topology location information of the content providing node; and the content locating system is further configured to determine the download location of the content requested to be downloaded according to at least one of the three factors of the current loading conditions, the content availability of the content providing node and network topology traffic optimization.

Preferably, the content locating system uses location information of the content providing node stored with the content requested to be downloaded as the download location information; or uses location information of the content providing node currently with lightest loads as the download location information; or uses location of the content providing node with minimum hop count with the download requester as the download location information; or uses location of the content providing node meeting at least two of the following conditions as the download location information: stored with the content requested to be downloaded, currently with lightest loads and with minimum hop count with the download requester.

Preferably, the content providing node is further configured to send a content download request to the content locating system, to download, acquire and provide the content according to the received information of the download location, and to provide the content information stored in itself to the content locating system.

Preferably, the delivery configuration comprises at least one of the following configurations: content fragmentation configuration, transmission configuration, location configuration; wherein, the content fragmentation configuration comprises at least one of the following configurations: fragmentation conducted or not, fragmentation rules, fragmentation size, fragmentation identifier, or naming rules of the fragmentation identifier; the transmission configuration comprises at least one of the following configurations: the transmission protocol used for content transmission, simplex or multiplex transmission, unicast or multicast transmission, transmission scheduling strategies; the location configuration comprises at least one of the following configurations: the address of location server and the protocol used for location.

Preferably, the content providing node is a content server, or a content download node, or a content source node.

Preferably, the content locating system notifies content upload location information of a content source to the content providing node when receiving the content upload location information; the content providing node downloads the corresponding content from the content source according to the content upload location information;

or, the content providing node downloads the corresponding content according to the content location information in the content source obtained from the content locating system or the download requester;

or, the content source inquires the content providing node from the content locating system and uploads the content in itself to the content providing node inquired.

According to another accept of the disclosure, a method for content delivery based on the content delivery network is provided, the content delivery network comprising a content locating system, a delivery configuration managing system and at least one content providing node; wherein the content providing node is configured to acquire and provide a content; the content locating system is configured to determine a download location of a content requested to be downloaded and provide the determined download location information to a content download requester; and the delivery configuration managing system is configured to maintain and/or generate delivery configuration information of the content; determine a delivery configuration of the content to be downloaded according to received information of the content requested to be downloaded, and notify the delivery to the download requester; the method comprising: the download requester providing information of the content requested to be downloaded to the delivery configuration managing system; the delivery configuration managing system determining a delivery configuration of the content to be downloaded according to the information of the content requested to be downloaded, and notifying the delivery configuration to the download requester; the download requester sending the information of the content requested to be downloaded to the content locating system; the content locating system determining a download location of a content requested to be downloaded according to the information of the related content requested to be downloaded, and notifies the download location to the download requester; the download requester downloading the content requested to be downloaded according to the download location information of the content requested to be downloaded and the delivery configuration.

Preferably, the information of the related content requested to be downloaded comprises ID information of the content or content fragmentation; the ID information of the content or content fragmentation comprises URL information and MD information of the content or content fragmentation.

Preferably, the step of the download requester downloading the content requested to be downloaded is: the download requester downloading the content requested to be downloaded according to the download location information of the content requested to be downloaded notified by the content locating system and the delivery configuration information notified by the delivery configuration managing system, or according to the download location information of the content requested to be downloaded and the delivery configuration information notified by the content locating system.

Preferably, the content providing node is further configured to send a content download request to the content locating system, download, to acquire and provide the content according to the received download location information, and to provide the content information stored in itself to the content locating system.

Preferably, the content locating system further acquires the current loading conditions of the content providing node, the content availability and the network topology location information; the content locating system further determines the download location of the content requested to be downloaded according to at least one of the three factors of the current loading conditions, the content availability of the content providing node, and the network topology.

Preferably, the content locating system uses the location information of the content providing node stored with the content requested to be downloaded as the information of the download location; or uses the location information of the content providing node currently with lightest loads as the information of the download location; or uses the location of the content providing node with minimum hop count with the download requester as the information of the download information; or uses the location of the content providing node meeting at least two of the following conditions as the information of the download location: stored with the content requested to be downloaded, currently with lightest loads and with minimum hop count with the download requester.

Preferably, the delivery configuration comprises at least one of the following configurations: content fragmentation configuration, transmission configuration, location configuration; wherein, the content fragmentation configuration comprises at least one of the following configurations: fragmentation conducted or not, fragmentation rules, fragmentation size, fragmentation identifier, or naming rules of the fragmentation identifier; the transmission configuration comprises at least one of the following configurations: the transmission protocol used for content transmission, simplex or multiplex transmission, unicast or multicast transmission, transmission scheduling strategies; the location configuration comprises at least one of the following configurations: the address of location server and the protocol used for location.

Preferably, the content providing node is a content server, or a content download node, or a content source node.

Preferably, the content locating system will notify the information of content upload location of a content source to the content providing node when receiving it; the content providing node downloads the corresponding content from the content source according to the information of the content upload location;

or, the content providing node downloads the corresponding content according to the information of the content location in the content source obtained from the content locating system or the download requester;

or, the content source inquires the content providing node from the content locating system and uploads the content in itself to the content providing node inquired.

The content delivery network according to the disclosure comprises a content locating system, a delivery configuration managing system and at least one content providing node; wherein the content providing node which is configured to store contents and can be a content server, a content download node or a content source node, etc.; the content locating system is configured to determine a download location of a content requested to be downloaded, in the disclosure, and to determine information of a proper download location for a content download requester according to the network topology location between the content providing node the content to be downloaded belongs to and the content download node, and the loading conditions of the content providing node; and the delivery configuration managing system is stored with related delivery configuration information determined for the content in advance according to which the download requester downloads the content. The technical solution of the disclosure supports various content delivery configurations with relatively low complexity and costs.

### BRIEF DESCRIPTION OF THE DRAWINGS

FIG. 1 is a schematic diagram of composition structure of a existing content delivery network;

FIG. 2A is a flow chart of the existing content delivery based on HTTP;

FIG. 2B is a flow chart of the existing content delivery based on P2P;

FIG. 3 is a structure schematic diagram of a content delivery network according to an embodiment of the disclosure;

FIG. 4 is a structure schematic diagram of information interaction among network elements of the content delivery network according to an embodiment of the disclosure;

FIG. 5 is a schematic diagram of a method for content delivery according to an embodiment of the disclosure;

FIG. 6 is a flow chart of delivering a webpage content according to an embodiment of the disclosure; and

FIG. 7 is a flow chart of delivering a streaming media content according to an embodiment of the disclosure.

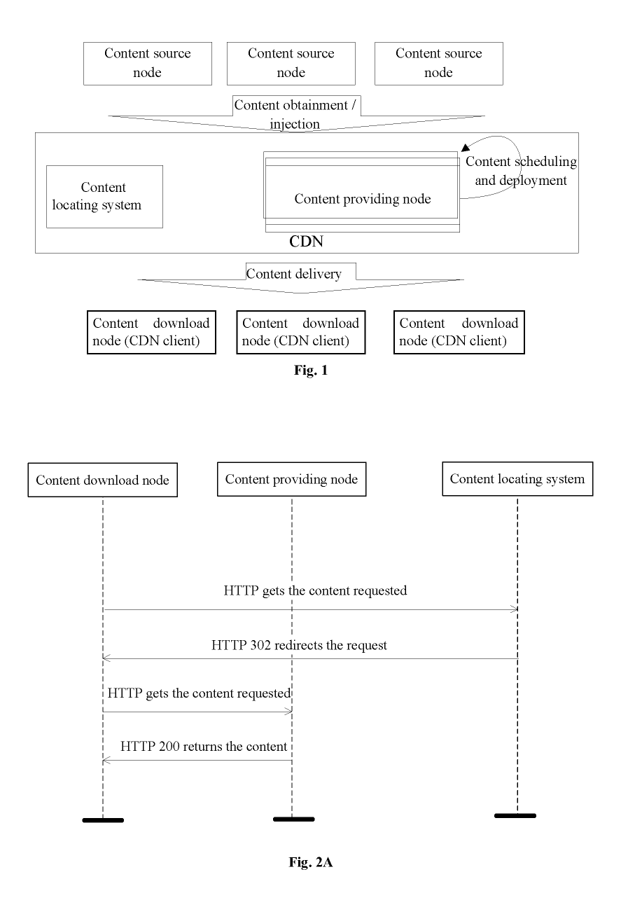

### DETAILED DESCRIPTION OF THE EMBODIMENTS

The basic thought of the disclosure is to realize supporting various content delivery methods through a content delivery network integrated with various content delivery methods. The content delivery network according to the disclosure comprises a content locating system, a delivery configuration managing system and at least one content providing node; wherein the content providing node configured to store contents and can be a content server, a content download node or a content source node, etc.; the content locating system is configured to determine a download location of a content requested to be downloaded, in the disclosure, and to determine information of a proper download location for a content download requester according to the network topology location between the content providing node the content to be downloaded belongs to and the content download node, and the loading conditions of the content providing node; and the delivery configuration managing system is stored with related delivery configuration information determined for the content in advance according to which the download requester downloads the content.

To clarify the objective, technical solution and advantages of the disclosure, the disclosure will be further illustrated in conjunction with the embodiments and drawings.

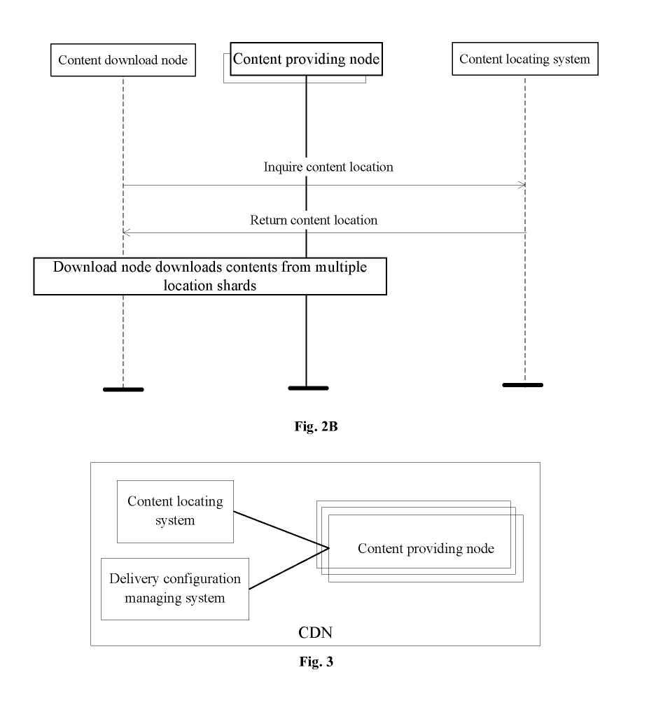

FIG. 3 is a structure schematic diagram of a content delivery network according to an embodiment of disclosure. As shown in FIG. 3, the content delivery network according to the disclosure comprises a content locating system, a delivery configuration managing system and at least one content providing node. The content locating system can comprise one or more nodes, and the delivery configuration managing system can comprise one or more nodes.

In the above, the content providing node is configured to send a content download request to the content locating system, download content according to received download location information, and to provide content information currently stored in itself to the content locating system. In the disclosure, the functions of the content providing node can be realized through a content providing node in the existing network, and can also be realized through a content source node or network download node (namely CDN client) in the existing network. That is to say, the content providing node according to the disclosure can be a content server used as content providing node, for example, a content server provided by content providers, or a intermediate content server used as a content providing node, for example, a server of agents of content providers, etc. Of course, a CDN client can also be used as a content providing node. Namely, in the content delivery method based on P2P, the content download node itself can also be used as a content providing node. The content providing node can store related contents, namely treating itself as a content source; can also not store related contents, only providing address information of content sources to users.

The content locating system is configured to determine a download location of a content requested to be downloaded and to provide the determined download location information to a content download requester. The content locating system according to the disclosure is configured to determine the content providing node where the content requested to be downloaded lies or the content providing node connected with the content source where the content requested to be downloaded lies according to related content information in a content download request after receiving the content download request from a content download node, and to provide location information of the determined content providing node as location information of the content requested to be downloaded to the content download node, thus the content delivery is realized. In the disclosure, the related content information in a download request mainly is identification information of the content, for example content name, content abstract, etc. Of course, it can also carry file type of a file the content belongs to and other information. Of course, the related content information can be address information of the content, for example, Uniform/Universal Resource Locator (URL) address information or Message-Digest Algorithm (MDA) information, such as, a value of Message-Digest Algorithm version 5 (MD 5), etc. It is only required to determine the identification information of the content requested to be downloaded. The content locating system according to the disclosure determines relatively reasonable content download location information for the content download node according to an optimized location information determining method configured, so as to occupy too many network resources. The content location algorithm can be set according to specific network demands.

The delivery configuration managing system is configured to maintain and/or generate delivery configuration information of the content; determine a delivery configuration of the content to be downloaded according to the received information of the content requested to be downloaded, and to notify the delivery configuration to the download requester. The delivery configuration managing system according to the disclosure is configured with configuration rules of various delivery contents, and the network element is also a core network element supporting the current various delivery methods. Namely, a certain type of delivery method can be supported by configuring corresponding content delivery rules in the delivery configuration managing system. The network element and its functions will be further illustrated hereinafter.

In the content delivery network according to the disclosure, the content locating system is further configured to acquire current loading conditions and network topology location information of the content providing node.

The content locating system is further configured to determine download location of the content requested to be downloaded according to at least one of the three factors of content availability, the current loading conditions and the network topology traffic optimization of the content providing node.

In the content delivery network according to the disclosure, the content locating system uses the location information of the content providing node stored with the content requested to be downloaded as the download location information; or the content locating system uses location information of the content providing node currently with lightest loads and connected with the content source stored with the content requested to be downloaded as the download location information; or the content locating system uses location of the content providing node with minimum hop count with the download requester and connected with the content source stored with the content requested to be downloaded as the download location information. Alternatively, the content locating system uses location of the content providing node meeting at least two of the following conditions as the download location information: stored with the content requested to be downloaded, currently with lightest loads and with minimum hop count with the download requester.

In the content delivery network according to the disclosure, the delivery configuration above includes at least one of the following configurations: content fragmentation configuration, transmission configuration and location configuration; wherein, the content fragmentation configuration includes at least one of the following configurations: fragmentation conducted or not, fragmentation rules, fragmentation size, fragmentation identifier or naming rules of the fragmentation identifier; the transmission configuration includes at least one of the following configurations: the transmission protocol used for content transmission, simplex or multiplex transmission, unicast or multicast transmission and transmission scheduling strategies; the location configuration includes at least one of the following configurations: address of location server and protocol used for location.

In the content delivery network according to the disclosure, the content providing node above is a content server, or a content download node, or a content source node.

In the content delivery network according to the disclosure, the content locating system above will notify content upload location information of a content source to the content providing node when receiving it. The content providing node downloads the corresponding content from the content source according to the content upload location information.

Or, the content providing node downloads the corresponding content according to the content location information in the content source obtained from the content locating system or the download requester.

Or, the content source inquires the content providing node from the content locating system and uploads the content in itself to the content providing node inquired.

In the disclosure, the content source can send the related content in itself positively to the corresponding content providing node; besides, the content providing node can obtain the related content by downloading it from the content source. The disclosure does not limit the method that content providing node obtains content information.

FIG. 4 is a schematic diagram of information interaction among network elements of the content delivery network according to an embodiment of the disclosure. As shown in FIG. 4, in the disclosure, the function of the content locating system can be realized by a content locating server, the function of the delivery configuration managing system can be realized by a content management server and the functions of the content providing nodes can be realized by multiple special content servers. The content delivery network according to the disclosure transmits and delivers the content provided by the content source node via the content delivery network itself finally to the content download node.

The content managing server above can provide the delivery configuration of the content required for the content download node. The delivery configuration includes content fragmentation configuration, transmission configuration and location configuration, etc. The content fragmentation configuration can be: fragmentation conducted or not, fragmentation rules, fragmentation size, fragmentation ID or naming rules of the fragmentation identifier, etc. The transmission configuration can be: the transmission protocol (which refers to the transmission protocol used for content transmission and includes User Datagram Protocol (UDP), Transmission Control Protocol (TCP), etc.), simplex or multiplex transmission, unicast or multicast transmission, transmission scheduling strategies (sequential transmission, key shard priority transmission, etc.) and content authenticity verification, etc. The location configuration can be: the address of location server, the protocol used for location and the address of content source node, etc.

The delivery configuration information is determined by the delivery configuration managing system according to content information and/or the configuration information set for content delivery. In the above, the content information can be reported by the content source or the content locating system, or the content information can be requested by the requester to the delivery configuration managing system. The configuration information can be from the preset configuration strategies, or the configuration strategies specified by content providers, etc. In the disclosure, the delivery configuration information is determined by content providers according to the content delivery method supported by the CDN and set according to specific demands.

In the CDN according to the disclosure, the content providing node reports the content information that it can provide to the content locating system. Specifically, the content providing node reports the content information currently stored to the content locating system periodically. The content locating system can be informed of content providing situation of each content providing node, so that the content locating system can determine source of the content requested to be downloaded accurately and quickly after receiving a content download request from a content download node and notify the location information of the content requested to be down to the content download node so as to be convenient for content delivery. Of course, the content can be reported in the form of content identifier. During reporting, all the content information in itself is reported to the content locating system in the first report, while in subsequent reports, it is only required to report the content information updated to the content locating system. For example, report the content information added or deleted comparing with the last time reported to the content locating system. The reporting of content information is done when maintenance personnel maintain the content on the content providing node, for example, it is only required to report the content information updated directly to the content locating system when contents are updated.

The content locating system can collect information of the content providing node. The information includes the current loading conditions and network topology location of the content providing node.

The functions of the delivery configuration managing system can be realized by meta data management system which can not only provide delivery configuration, but also other data of a content, such as the author, type and resolution of the content.

A content of a content source can enter the content delivery network in this way: a content source requests a content upload location from the content locating system; the content locating system provides the content upload location to the content source; the content source uploads the related content to the content providing node providing the upload location according to the content upload location acquired.

A content of a content source can also enter the content delivery network in this way: the content providing node acquires address of a content source (provided by the content locating system or content download node) and downloads contents from the content source.

A content locating server can provide a content download node with the addresses of at least one content server that can provide the content required. A content server can provide a content download node with the content requested to be downloaded by it.

According to an embodiment of the disclosure, a method for content delivery is also provided and applied in the content delivery network above. The method for content delivery according to the disclosure will be further illustrated with specific examples hereinafter.

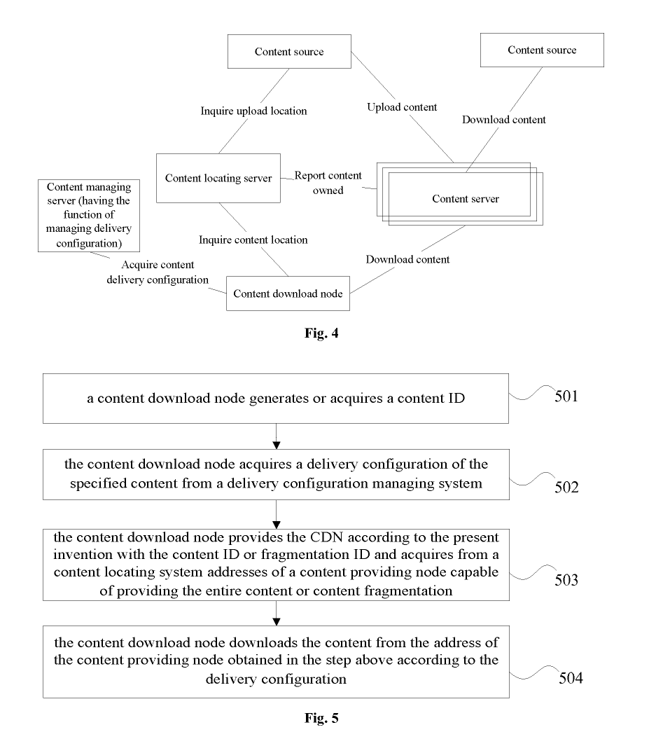

FIG. 5 is a schematic diagram of the method for content delivery according to the embodiment of the disclosure. As shown in FIG. 5, the method for content delivery according to the embodiment of the disclosure includes the following steps.

Step 501, a content download node generates or acquires a content ID. The content ID can be input manually by users or provided by portal servers, etc. Content ID can be URL, MD5 value, etc. Users send the identification information of the content requested to be downloaded via the content download node to the CDN of the disclosure.

Step 502, the content download node acquires a delivery configuration of the specified content from a delivery configuration managing system. The content download node provides the content ID of the content required to the CDN according to the disclosure to determine the content specified.

Step 503, according to the delivery configuration acquired, the content download node provides the CDN according to the disclosure with the content ID or fragmentation ID, inquires and acquires from a content locating system addresses of at least one content providing node capable of providing the entire content or content fragmentation. The content fragmentation ID can be generated according to certain rules and also can included in the delivery configuration information, as acquired in Step 502. If the content fragmentation ID is generated according to certain rules which can be agreed default rules, provided by portal servers or included in the delivery configuration information provided by the delivery configuration managing server.

Step 504, the content download node downloads the content from the address of the content providing node obtained in the step above according to the delivery configuration.

In Step 503 above, the content locating system can take one or more factors of the content availability, loading of the content providing node, traffic optimization so as to determine the download location of the content download node. In the situation that other conditions are the same, the content locating system gives a priority to the content providing node already with the content (stored with the content). In the situation that other conditions are the same, the content locating system gives a priority to the content providing node with lightest loads. In the situation that other conditions are the same, the content locating system gives a priority to the content providing node nearest to the download node network topology.

In the steps above, the delivery configuration can include content fragmentation configuration, transmission configuration and location configuration. The content fragmentation configuration can be: fragmentation conducted or not, fragmentation rules, fragmentation size, fragmentation ID or naming rules of the fragmentation identifier. The transmission configuration can be: the transmission protocol (UDP, TCP, etc.), single or multiple-downloading, unicast or multicast transmission and transmission scheduling strategies (sequential downloading, key shard priority downloading, etc.). The location configuration can be: the address of location server and the protocol used for location.

In the steps above, the content download location can be: an address of a special content server, a download node and a content source node.

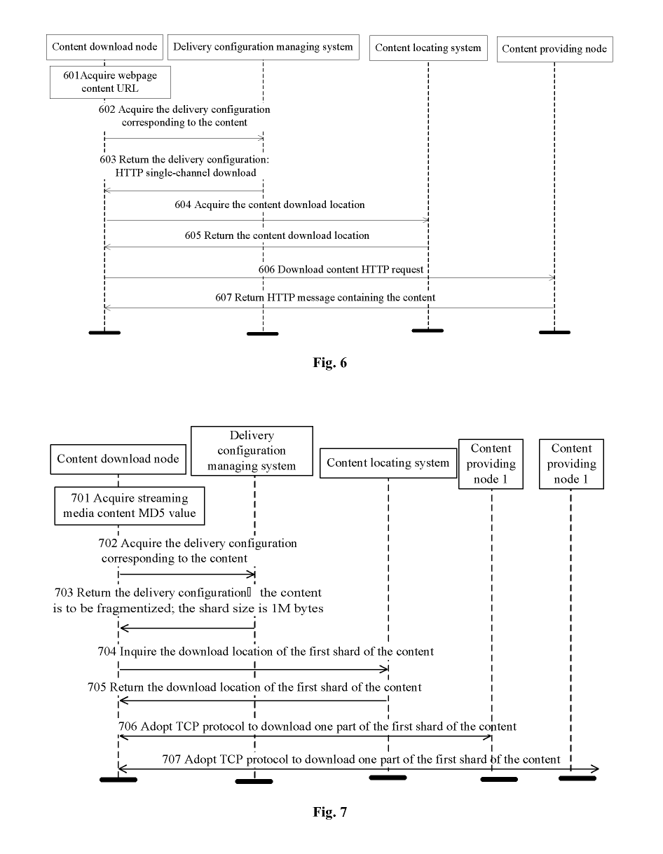

In the disclosure, the delivery configuration varies with content. FIG. 6 and FIG. 7 show the flow charts of embodiments of delivering a webpage content and a streaming media content respectively according to the disclosure.

FIG. 6 is a flow chart of delivering a webpage content according to an embodiment of the disclosure. As shown in FIG. 6, the method for webpage content delivery according to the embodiment of the disclosure includes the following steps.

Step 601, a content download node generates or acquires a content ID. For example, the content ID is an URL input manually.

Step 602 to Step 603, the content download node sends the content ID to the delivery configuration managing system of the CDN according to the disclosure to indicate the content requested to be downloaded. The delivery configuration managing system determines the delivery configuration information of the content according to the content ID and sends the delivery configuration to the content download node. The delivery configuration of the specified content is acquired from the delivery configuration managing system. In the above, the content download node provides the content ID of the content required to the content managing system.

Step 604 to Step 605, the content download node provides the content ID to a content locating system, inquires and acquires from the content locating system an address of a content providing node capable of providing the entire content. In the step, the provision of the content ID to the content locating system is determined by the content download node according to the delivery configuration information received. If the content is fragmentized, the content ID is fragmentation ID; otherwise, it is still content ID.

Step 606 to Step 607, according to the delivery configuration, the content download node adopts HTTP protocol to single-channel download corresponding contents according to the acquired address of the content providing node. In the embodiment, the delivery configuration is: content not fragmentized, adopting HTTP for single-channel downloading. In the embodiment, the content download location is the address of a special content server.

FIG. 7 is a flow chart of delivering a streaming media content according to an embodiment of the disclosure. As shown in FIG. 7, the method for streaming media content delivery according to the embodiment of the disclosure includes the following steps.

Step 701, a content download node generates or acquires a content ID. In the above, the content ID is MD5 value provided by a portal server.

Step 702 to Step 703, the content download node sends the content ID to the delivery configuration managing system of the CDN according to the disclosure to indicate the content requested to be downloaded. The delivery configuration managing system determines delivery configuration information of the content according to the content ID and sends the delivery configuration to the content download node.

Step 704 to Step 705, the content download node provides fragmentation ID of the first fragmentation of the content to a content locating system, inquires and acquires from the content locating system addresses of two content providing nodes capable of providing the content fragmentation. In the above, the content fragmentation ID is generated according to agreed default rules: the fragmentation ID is generated by adding fragmentation serial number after content ID.

Step 706 to Step 707, according to the delivery configuration, the content download node adopts TCP protocol to download the first fragmentation of the content from the two content providing nodes acquired from the step above. The content download node downloads different parts of the first fragmentation from the two content providing nodes respectively.

In the embodiment, the delivery configuration is: the content is to be fragmentized; the shard size is 1 M bytes; adopting TCP transmission protocol; multiple-channel downloading. In the embodiment, the content download locations are the addresses of two special content servers.

Step 706 and Step 707 are interchangeable, and can also be conducted together. The above is just the preferred embodiment of the disclosure, and is not intended to limit the protection scope of the disclosure.

What is claimed is:

1. A content delivery network, comprising a content locating system, a delivery configuration managing system and at least one content providing node; wherein,
the content providing node is configured to acquire and provide a content;
the content locating system is configured to determine a download location of a content requested to be downloaded and provide the determined download location information to a content download requester; and
the delivery configuration managing system is configured to maintain and/or generate delivery configuration information of the content; determine a delivery configuration of the content to be downloaded according to received information of the content requested to be downloaded, and notify the delivery configuration to the download requester.

2. The content delivery network according to claim 1, wherein the content locating system is further configured to acquire current loading conditions, content availability and network topology location information of the content providing node; and
the content locating system is further configured to determine the download location of the content requested to be downloaded according to at least one of the three factors of the current loading conditions, the content availability of the content providing node and network topology traffic optimization.

3. The content delivery network according to claim 2, wherein the content locating system uses location information of the content providing node stored with the content requested to be downloaded as the download location information ; or uses location information of the content providing node currently with lightest loads as the download location information ; or uses location of the content providing node with minimum hop count with the download requester as the download location information; or uses location of the content providing node meeting at least two of the following conditions as the download location information: stored with the content requested to be downloaded, currently with lightest loads and with minimum hop count with the download requester.

4. The content delivery network according to claim 1, wherein the delivery configuration comprises at least one of the following configurations: content fragmentation configuration, transmission configuration, location configuration; wherein, the content fragmentation configuration comprises at least one of the following configurations: fragmentation conducted or not, fragmentation rules, fragmentation size, fragmentation identifier, or naming rules of the fragmentation identifier; the transmission configuration comprises at least one of the following configurations: transmission protocol used for content transmission, simplex or multiplex transmission, unicast or multicast transmission, transmission scheduling strategies; the location configuration comprises at least one of the following configurations: address of location server and the protocol used for location.

5. The content delivery network according to claims 1, wherein the content locating system notifies content upload location information of a content source to the content providing node when receiving the content upload location information; the content providing node downloads the corresponding content from the content source according to the content upload location information;
or, the content providing node downloads corresponding content according to the content location information in the content source obtained from the content locating system or the download requester;
or, the content source inquires the content providing node from the content locating system and uploads the content in the content source to the content providing node inquired.

6. A method for content delivery based on a content delivery network, the content delivery network comprises a content locating system, a delivery configuration managing system and at least one content providing node; wherein the content providing node is configured to acquire and provide a content; the content locating system is configured to determine a download location of a content requested to be downloaded and provide the determined download location information to a content download requester; and the delivery configuration managing system is configured to maintain and/or generate delivery configuration information of the content; determine a delivery configuration of the content to be downloaded according to received information of the content requested to be downloaded, and notify the delivery configuration to the download requester; the method comprises:
the download requester providing information of the content requested to be downloaded to the delivery configuration managing system;
the delivery configuration managing system determining a delivery configuration of the content requested to be downloaded according to the information of the content requested to be downloaded, and notifying the delivery configuration to the download requester;
the download requester sending the information of the content requested to be downloaded to the content locating system;
the content locating system determining download location of a content requested to be downloaded according to the information of the related content requested to be downloaded, and notifies the download location information to the download requester; and
the download requester downloading the content requested to be downloaded according to the download location information of the content requested to be downloaded and the delivery configuration.

7. The method for content delivery according to claim 6, wherein, the information of the related content requested to be downloaded comprises ID information of the content or content fragmentation; the ID information of the content or content fragmentation comprises Universal Resource Locator (URL) information and Message-Digest (MD) information of the content or content fragmentation.

8. The method for content delivery according to claim 6, wherein the step of the download requester downloading the content requested to be downloaded comprises:
the download requester downloading the content requested to be downloaded according to the download location information of the content requested to be downloaded notified by the content locating system and the delivery configuration information notified by the delivery configuration managing system, or according to the download location information of the content requested to be downloaded and the delivery configuration information notified by the content locating system.

9. The method for content delivery according to claim 6, wherein the content providing node is further configured to send a content download request to the content locating system, download, acquire and provide the content according to the received download location information, and provide the content information stored in the content providing node to the content locating system.

10. The method for content delivery according to claim 6, wherein the delivery configuration comprises at least one of the following configurations: content fragmentation configuration, transmission configuration, location configuration; wherein, the content fragmentation configuration comprises at least one of the following configurations: fragmentation conducted or not, fragmentation rules, fragmentation size, fragmentation identifier, or naming rules of the fragmentation identifier; the transmission configuration comprises at least one of the following configurations: the transmission protocol used for content transmission, simplex or multiplex transmission, unicast or multicast transmission, transmission scheduling strategies; and the location configuration comprises at least one of the following configurations: the address of location server and the protocol used for location.

11. The content delivery network according to claim 2, wherein the content locating system notifies content upload location information of a content source to the content providing node when receiving the content upload location information; the content providing node downloads the corresponding content from the content source according to the content upload location information;
or, the content providing node downloads corresponding content according to the content location information in the content source obtained from the content locating system or the download requester;
or, the content source inquires the content providing node from the content locating system and uploads the content in the content source to the content providing node inquired.

12. The content delivery network according to claim 3, wherein the content locating system notifies content upload location information of a content source to the content providing node when receiving the content upload location information; the content providing node downloads the corresponding content from the content source according to the content upload location information;
or, the content providing node downloads corresponding content according to the content location information in the content source obtained from the content locating system or the download requester;
or, the content source inquires the content providing node from the content locating system and uploads the content in the content source to the content providing node inquired.

13. The content delivery network according to claim 4, wherein the content locating system notifies content upload location information of a content source to the content providing node when receiving the content upload location information; the content providing node downloads the corresponding content from the content source according to the content upload location information;
or, the content providing node downloads corresponding content according to the content location information in the content source obtained from the content locating system or the download requester;
or, the content source inquires the content providing node from the content locating system and uploads the content in the content source to the content providing node inquired.
